(19) United States
(12) Patent Application Publication
(10) Pub. No.: US 2010/0304107 A1
(43) Pub. Date: Dec. 2, 2010

(54) LAYERED COATING FOR EROSION PROTECTION

(75) Inventors: Aaron T. Nardi, East Granby, CT (US); Jun Shi, Glastonbury, CT (US); Blair A. Smith, South Windsor, CT (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: UNITED TECHNOLOGIES CORPORATION, Hartford, CT (US)

(21) Appl. No.: 12/472,871

(22) Filed: May 27, 2009

(51) Int. Cl. B32B 7/02; B05D 1/36

(52) U.S. Cl. 428/217; 427/419.1; 427/419.7

(57) ABSTRACT

A coating for protecting a surface against erosion when contacted by particles having a range of particle sizes or by high velocity fluid impingement includes a first coating on the surface forming a high bulk or composite hardness coating; and a hard ceramic coating on the first coating having a hardness higher than the hardness of the first coating and the erosion particles.

### BACKGROUND

The present invention relates to a layered coating sheath for erosion protection of metal parts that are subjected to erosive forces of particulate such as sand, dirt and dust, or liquid impingement such as rain or other fluids.

Erosion of components of aircraft propulsion systems such as rotor blades, propeller blades, fan blades and fan inlet cases, is an issue that has continued to be a source of problems for the industry. Other industries where fluid handling or air handling equipment can be subject to particulate or fluid impingement suffer from similar issues. These might include wind or water turbines, impellers, sea vessel propellers, or large commercial piping systems. Of particular concern is erosion caused by sand, because sand typically contains a wide range of particle sizes. Sand may contain particles as small as 20 to 30 microns and as large as 1,000 to 2,000 microns. Finer sand tends to produce slow abrasive wear with little impact energy keeping the depth of effected material low. Fluids can also produce damaging results if impinged upon the substrate in a repetitive manner. In this case again larger fluid droplets at higher velocity can produce high stresses deep into the material. On helicopters for instance, the leading edge of the rotor blade may be fitted with an abrasion strip or sheath, often fabricated from titanium and/or nickel. These blades are subjected to severe erosion, especially on takeoff and landing in a desert location or in severe rain.

Sheathing has been used in the past to address erosion problems on erosion prone equipment such as those previously mentioned. Sheathing often consists of nickel, cobalt, titanium, nickel-cobalt alloy, or in some cases elastomers to resist the erosion. Materials used for sheathing need to be tough with high strain to failure values or need to be able to absorb high amounts of energy without damage accumulation to perform well in high incident angle erosion. These materials need high hardness and abrasion resistance to resist erosion at low angles of incidence.

Thin ceramic layers like titanium nitride tend to spall when used on traditional sheath materials like nickel. Cermets, or ceramic materials held together by a metal matrix, such as tungsten carbide-cobalt can have a higher overall hardness than much of the naturally occurring particulate found in erosive environments. Additionally, these materials may be able to absorb some of the impact energy due to the more ductile matrix material. This leads to a coating that may perform generally well with very little surface deformation occurring. This same coating can however fail from erosion of the softer metal between the carbide particles, which then allows the carbide particles themselves to become dislodged. Some layers of erosion protection materials like these are effective against one range of particle size and not against a different range of particle size. Nothing has been found to cover the whole range of particle sizes that are encountered in many environments. Similarly rain or fluid erosion may be able to damage the softer matrix or may propagate matrix damage caused by particulate erosion.

### SUMMARY

A layered coating, includes a first layer applied to the object being protected from erosion such as by sand, dirt and other particles, or by impingement of fluids such as rain. This layer may also be applied to a sheath or similar substrate that then is attached to the object being protected. This first layer minimizes surface deformation and absorbs the impact energy of the particulate of fluid impinging the surface. A second layer on top of the first layer is much harder and resists abrasion of the not as hard first layer.

The first layer is relatively hard, such as having a hardness of from about 10 to about 20 Gigapascals, and is relatively thick, such as from about 75 to 500 microns. The second layer is much harder, such as from about 19 to about 40 Gigapascals or higher, and is relatively thin, such as from about 1 to about 25 microns. The function of the first, thicker layer is to provide resistance to penetration by particles on impact sufficiently to minimize large surface deformations that cause thin coating spallation and debonding. The second, thinner layer resists abrasion of the softer metal matrix of the first layer. The first thicker layer may be formed, for example, from tungsten-carbide-cobalt, tungsten-carbide-cobalt-chrome, chrome-carbide-nickel-chrome, chrome-carbide-nickel, diamond-nickel, or other metal matrix materials with ceramic reinforcement. The second thin layer may be formed, for example, from titanium nitride, diamond, chrome nitride, diamond-like-carbon, cubic boron nitride, boron carbide, titanium carbide, or a combination of these or other high hardness ceramic thin coatings. Since hardness is often measured with a diamond, it is difficult to have a precise value for the maximum hardness for this layer, but the minimum value should at least exceed the maximum possible hardness of any particulate erodent expected.

### BRIEF DESCRIPTION OF THE DRAWINGS

FIG. 1 is a schematic view of a surface protected by the layered coating sheath of the present invention.

FIGS. 2A and 2B are photographs of the surface of a substrate with properties of layer 1 of this invention with a CVD diamond layer 2 material similar to the concept of FIG. 1, before and after the surface has been subjected to erosion with sand.

FIGS. 3A and 3B are photographs of a titanium metal which is softer than layer 1 described herein with a CVD diamond layer 2 applied, before and after the surface has been subjected to erosion with sand.

FIGS. 4A and 4B are photographs of the surface of a substrate with properties of layer 1 with a chromium nitride layer 2 material applied before and after the surface has been subjected to erosion with sand.

### DETAILED DESCRIPTION

A coating is provided to protect a surface against erosion when contacted by particles such as sand, dirt and the like, particularly when the particles have a range in particle size. The first coating is applied to form a deformation resistant surface that has a composite hardness exceeding that of the erodent expected but is a composite of hard materials with a softer ductile matrix to absorb energy. The second coating is applied to the first coating with a hardness higher than the first coating, but also with a hardness consistent across the surface.

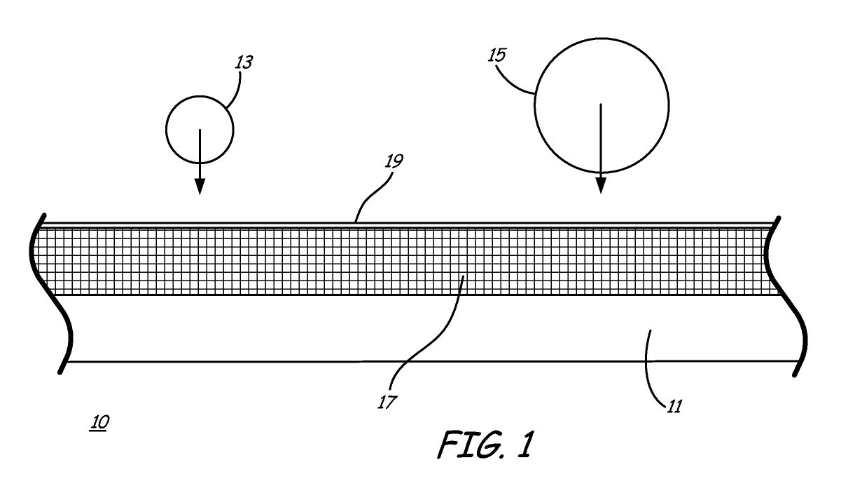

FIG. 1 illustrates the erosion protection system 10 for protecting a substrate 11 that has a relatively low hardness such that it would be eroded by contact with erosion particles 13 and 15 that are of different particle sizes. Sand, for example, can range in particle size from less than 20 microns to more than 2,000 microns. Erosion protection system 10 also is effective against particles of a generally similar size. Substrate 11 represents any surface that is exposed to erosion. For example, titanium and nickel are two surfaces that are used in leading edges of helicopter rotors. They are strong for their intended purpose but they erode and require frequent repair or replacement.

Surface 11 is first covered with a high bulk hardness coating 17 that is relatively thick, such as from about 75 to about 500 microns thick. Coating 17 thickness can also range from 100 to 300 microns. Cermets, which are composites of very hard ceramic particles or fibers in a matrix of a more ductile metal combine the properties of ceramic and metallic materials, and form coatings that may be used for coating 17. Examples are tungsten-carbide-cobalt, tungsten-carbide-cobalt-chrome, chrome-carbide-nickel-chrome, chrome-carbide-nickel, diamond-nickel, or other metal matrix materials with ceramic reinforcement. The hardness of coating 17 ranges from about 10 to about 20 Gigapascals. This hardness should vary dependent on the hardness of the erodent expected in service. For instance for an environment dominated by erosion by silica, a more narrow range of about 15 to about 18 Gigapascals may be used.

The high bulk hardness coating 17 is then coated with a hard coating 19 that is much harder than coating 17, and is also much thinner. Coating 19 may range in thickness from less than 1 micron to more than 25 microns. Thicknesses from about 2 to about 15 microns, and more particularly about 3 to 10 microns have proven very effective. Coating 19 is a ceramic coating, and should have a hardness ranging from about 18 to about 40 Gigapascals or higher. Examples of such ceramic coatings are titanium nitride, diamond, chrome nitride, diamond-like-carbon, cubic boron nitride, boron carbide, titanium carbide, or a combination of these or other high hardness ceramic thin coatings. A narrower range is from about 18 to about 30 Gigapascals.

Coating 17 may be applied to substrate 11 by HVOF, cold spray or other processes used for applying a cermet on to a substrate. Coating 19 is applied to first coating 17 by chemical vapor deposition or physical vapor deposition, and by other methods of applying a thin ceramic coating to a surface.

In order to demonstrate the efficacy of the present invention, a number of tests were performed to compare the coatings of this invention with other coatings. Test strips were prepared and subjected to Ottawa sand impacting on the surface of the strip at an angle of 90° and with a velocity of 800 feet/second (244 meters/second).

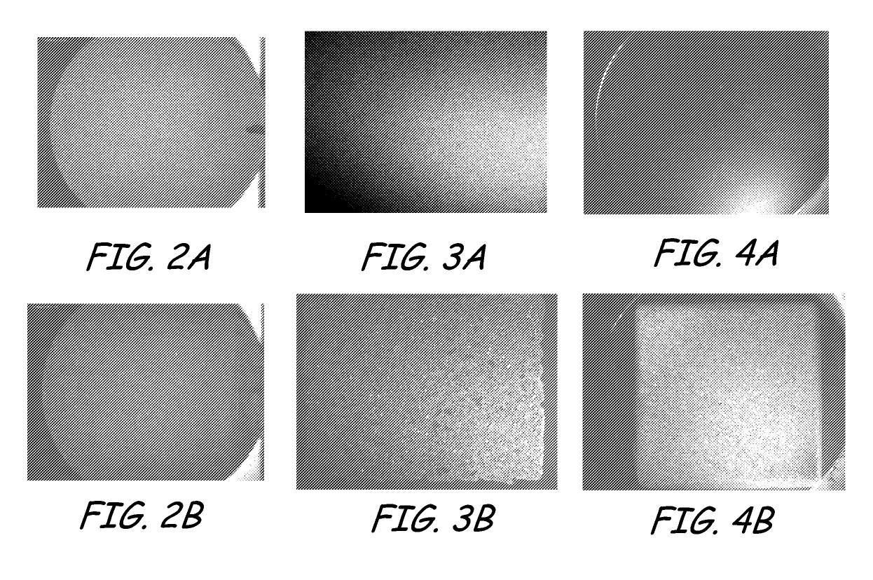

FIG. 2A is a photograph of a chemical vapor deposited diamond coating on a tungsten carbide-cobalt substrate. FIG. 2B is a photograph of the coupon of FIG. 2A after being hit by 500 g of sand. As can be seen, there is essentially no erosion of the coating.

FIG. 3A is a photograph of the same chemical vapor deposited diamond coating on a soft titanium alloy such as the alloys used as a leading edge protector on a helicopter rotor blade. FIG. 3B illustrates the sample after only 2 g of sand impacting under the same test conditions. Clearly the protective diamond film has been removed from the surface and will erode at the relatively high titanium erosion rate.

FIG. 4A is a photograph of a chrome nitride layer that has been applied with physical vapor deposition on a tungsten carbide-cobalt substrate. FIG. 4B illustrates the sample after 100 g of sand has hit it, which is a fifty percent improvement.

Presented below in Table I are sand erosion test results performed on titanium and nickel abrasion strips currently used on helicopter rotor blades, again with Ottawa sand impacting at 90° impact and at a speed of 800 feet/second (244 meters/second). The values are based on an uncoated nickel or titanium value of 1.0.

TABLE I

| | | Improvement | Improvement |
|---|---|---|---|
| | | Relative | Relative |
| Thin film coating | Substrate | to Nickel | to Titanium |
| Diamond | Tungsten carbide with | 3851 | 8003 |
| | 6% cobalt | | |
| Diamond | Titanium | 0.45 | 0.93 |
| Chrome Nitride | Tungsten carbide with | 18 | 37 |
| | 10% cobalt | | |

As can be seen, the use of a thin film coating with the substrate of this invention provides substantial improvement in erosion resistance, similar to that shown in FIGS. 2A-4B.

The erosion protection system of the present invention may be used on helicopter rotor blades, propellers, land-based turbines, power generators, and fan blades on turbine engines, as well on any surface that is subjected to particle erosion, liquid impingement erosion, or a combination of the two.

Although the present invention has been described with reference to preferred embodiments, workers skilled in the art will recognize that changes may be made in form and detail without departing from the spirit and scope of the invention.

1. A coating for protecting a surface against erosion when contacted by particles having a range of particle sizes or by repetitive high velocity fluid impingement, comprising:
a first coating sufficiently high in bulk composite hardness to resist deformation from particles or fluid impact pressure; and
a second continuously hard coating on the first coating having a hardness higher than the first coating and the hardness of the particles.

2. The coating of claim 1, wherein the particles are sand having a particle size ranging from about 20 microns to about 2000 microns.

3. The coating of claim 1, wherein the fluid is water or other fluids impinging the component repetitively with high velocity.

4. The coating of claim 1, wherein the first coating is a cermet.

5. The coating of claim 3, wherein the cermet is selected from the group consisting of tungsten-carbide-cobalt, tungsten-carbide-cobalt-chrome, chrome-carbide-nickel-chrome, chrome-carbide-nickel, diamond-nickel, or other metal matrix materials with ceramic reinforcement.

6. The coating of claim 1, wherein the second coating is a thin ceramic layer.

7. The coating of claim 5, wherein the ceramic layer is selected from the group consisting of titanium nitride, diamond, chrome nitride, diamond-like-carbon, cubic boron nitride, boron carbide, titanium carbide, or a combination of these.

8. The coating of claim 1, wherein the first coating has a thickness from about 75 to 500 microns.

9. The coating of claim 7, wherein the first coating has a hardness of from about 10 to about 20 Gigapascals.

10. The coating of claim 1, wherein the second coating has a thickness from about 1 to about 25 microns.

11. The coating of claim 7, wherein the second coating has a hardness from about 18 to about 40 pascals.

12. A method for protecting a surface against erosion when contacted by particles having a range of particle sizes or by repetitive high velocity fluid impingement, comprising:
applying a first sufficiently high in bulk or composite hardness to resist deformation from particles or fluid impact pressure; and
applying a second continuously hard coating on the first coating having a hardness higher than the first coating and the hardness of the particles.

13. The method of claim 12, wherein the particles are sand having a particle size ranging from about 20 microns to about 2000 microns.

14. The method of claim 12, wherein the fluid is water or other fluids impinging the component repetitively with high velocity

15. The method of claim 12, wherein the first coating is a cermet.

16. The method of claim 15, wherein the cermet is selected from the group consisting of tungsten-carbide-cobalt, tungsten-carbide-cobalt-chrome, chrome-carbide-nickel-chrome, chrome-carbide-nickel, diamond-nickel, or other metal matrix materials with ceramic reinforcement.

17. The method of claim 12, wherein the second coating is a thin ceramic layer.

18. The method of claim 17, wherein the second coating is selected from the group consisting of titanium nitride, diamond, chrome nitride, diamond-like-carbon, cubic boron nitride, boron carbide, titanium carbide, or a combination of these.

19. The method of claim 12, wherein the first coating has a thickness from about 75 to 500 microns and a hardness of from about 10 to about 20 Gigapascals.

20. The method of claim 12, wherein the hard coating has a thickness from about 1 to about 25 microns and a hardness from about 18 to about 40 Gigapascals.

21. A component of an aircraft propulsion system, the component comprising:
a substrate,
a protective coating on the surface of the substrate, the protective coating comprising:
a cermet coating on the substrate forming a high bulk or composite hardness coating, wherein the cermet is selected from the group consisting of tungsten-carbide-cobalt, tungsten-carbide-cobalt-chrome, chrome-carbide-nickel-chrome, and diamond-nickel; and
a hard ceramic coating on the cermet coating having a higher and more continuous hardness than the cermet and a higher hardness than the erosive particles, wherein the ceramic coating is selected from the group consisting of titanium nitride, diamond, chrome nitride, diamond-like-carbon, cubic boron nitride, boron carbide, titanium carbide, or a combination of these.

22. The protective coating of claim 21, wherein the cermet coating has a thickness from about 75 to 500 microns and a hardness of from about 10 to about 20 Gigapascals and the hard ceramic coating has a thickness from about 1 to about 25 microns and a hardness from about 18 to about 40 Gigapascals.
